(19) United States
(12) Patent Application Publication
(10) Pub. No.: US 2026/0184956 A1
(43) Pub. Date: Jul. 2, 2026

(54) POLYESTER, MULTI-CARBOXYLIC POLYESTER RESIN, COATING MATERIAL

(71) Applicant: INDUSTRIAL TECHNOLOGY RESEARCH INSTITUTE, Hsinchu (TW)

(72) Inventors: Hung-Cheng LIN, Taipei City (TW); Yuan-Chang HUANG, Hsinchu City (TW); Wen-Yang CHEN, Qionglin Township (TW); Wei-Cheng TANG, Hsinchu City (TW)

(73) Assignee: INDUSTRIAL TECHNOLOGY RESEARCH INSTITUTE, Hsinchu (TW)

(21) Appl. No.: 19/007,281

(22) Filed: Dec. 31, 2024

(51) Int. Cl. C09D 167/02; C08G 63/20

(52) U.S. Cl. CPC C09D 167/02; C08G 63/20

(57) ABSTRACT

A polyester is provided. The polyester is formed by reacting monomers, and the monomers include 15 to 20 parts by mole of (a) aliphatic triol monomer; 15 to 35 parts by mole of (b) first diol monomer; 60 to 80 parts by mole of (c) second diol monomer; and 100 parts by mole of (d) aliphatic diacid monomer or aliphatic anhydride monomer. The polyester may react with multi-carboxylic compound or anhydride to form a multi-carboxylic polyester resin. The multi-carboxylic polyester resin can be used to form an aqueous coating material.

### CROSS REFERENCE TO RELATED APPLICATIONS

### Technical Field

The technical field relates to a polyester and a multi-carboxylic polyester resin.

### BACKGROUND

Polyesters are widely used in coating materials, adhesive agents, celluloses, and the like. Synthesis of conventional solvent-based polyester resins is matured, and the coating layers have excellent physical properties. However, solvent-based coating materials often require a large amount of organic solvent to reduce their viscosities for subsequent processing and continuous production. Organic solvent presents concerns about production, storage, and use, and has a negative impact on the environment.

Accordingly, a novel non-solvent-based resin is called for to address the above issues of the above coating material.

### SUMMARY

One embodiment of the disclosure provides a polyester formed by reacting monomers, and the monomers include: 15 to 20 parts by mole of (a) aliphatic triol monomer; 15 to 35 parts by mole of (b) first diol monomer; 60 to 80 parts by mole of (c) second diol monomer; and 100 parts by mole of (d) aliphatic diacid monomer or aliphatic anhydride monomer. (b) The first diol monomer has a chemical structure of

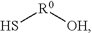

wherein R⁰ is C₂₋₆ alkylene group. (c) The second diol monomer has a chemical structure of

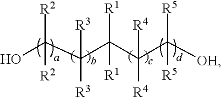

wherein each of a, b, c, and d is independently an integer of 0 to 6, and a+b+c+d≠0; and R¹ is C₁₋₆ alkyl group, and each R¹ is the same; R² is H or C₁₋₆ alkyl group, and each R² is the same; R³ is H or C₁₋₆ alkyl group, and each R³ is the same; R⁴ is H or C₁₋₆ alkyl group, and each R⁴ is the same; and R⁵ is H or C₁₋₆ alkyl group, and each R⁵ is the same.

One embodiment of the disclosure provides a multi-carboxylic polyester resin having a ratio of an acid value to a hydroxyl value of 1.2:1 to 2.0:1, and having a hydroxyl value of 35 mg KOH/g to 60 mg KOH/g. The multi-carboxylic polyester resin is formed by reacting a polyester with multi-carboxylic compound or anhydride, and the polyester has a hydroxyl value of 60 mg KOH/g to 90 mg KOH/g.

One embodiment of the disclosure provides a coating material, including: 100 parts by weight of an aqueous resin, formed by neutralizing the described multi-carboxylic polyester resin with an alkaline; 250 to 300 parts by weight of water; and 25 to 45 parts by weight of a curing agent.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a polyester formed by reacting monomers, and the monomers include: 15 to 20 parts by mole of (a) aliphatic triol monomer; 15 to 35 parts by mole of (b) first diol monomer; 60 to 80 parts by mole of (c) second diol monomer; and 100 parts by mole of (d) aliphatic diacid monomer or aliphatic anhydride monomer. If the amount of (a) the aliphatic triol monomer is too low, it will be difficult to increase the molecular weight of the polyester, branch points cannot be formed, and the physical properties of resin cannot be enhanced. If the amount of (a) the aliphatic triol monomer is too high, it will be difficult to control the reaction, and gelling will easily occur. If the amount of (b) the first diol monomer is too low, the viscosity of the resin product will be relatively high. If the amount of (b) the first diol monomer is too high, the molecular weight of the resin product will be relatively low. If the amount of (c) the second diol monomer is too low, the hydrolysis resistance of the resin product will be poor. If the amount of (c) the second diol monomer is too high, the crystallinity of the resin product will be relatively low, and a coating layer prepared by a coating material including the resin product will have relatively lower transparency and gloss.

In some embodiments, (a) the aliphatic triol monomer includes glycerin, trimethylolpropane, trimethylolethane, polycaprolactone triol, stigmastane-3,5,6-triol, (5alpha)-cholestane-3,5,6-triol, or a combination thereof.

In some embodiments, (b) the first diol monomer has a chemical structure of

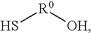

wherein R⁰ is C₂₋₆ alkylene group. In other words, the carbon chain of (b) the first diol monomer is free of another substituent group. If the carbon number of R⁰ is too high, the viscosity of the polyester will obviously decrease, and the prepared coating layer will have a low hardness and an obviously degraded weather-resistance. For example, (b) the first diol monomer includes ethylene glycol, 1,3-propylene glycol, 1,4-butanediol, 1,5-pentanediol, or a combination thereof.

In some embodiments, (c) the second diol monomer has a chemical structure of

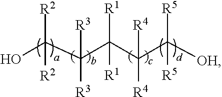

wherein each of a, b, c, and d is independently an integer of 0 to 6, and a+b+c+d≠0 (e.g., a+b+c+d=2 to 24); and R¹ is C₁₋₆ alkyl group, and each R¹ is the same; R² is H or C₁₋₆ alkyl group, and each R² is the same; R³ is H or C₁₋₆ alkyl group, and each R³ is the same; R⁴ is H or C₁₋₆ alkyl group, and each R⁴ is the same; and R⁵ is H or C₁₋₆ alkyl group, and each R⁵ is the same. In other words, (c) the second diol monomer must contain two same substituent groups (i.e., R¹, C₁₋₆ alkyl groups) substituted on the same carbon atom. For example, (c) the second diol monomer includes neopentyl glycol, isopentyl glycol, 3,3-dimethyl-1,5-pentanediol, 2,5-dimethyl-2,5-hexanediol, or a combination thereof.

In some embodiments, (d) the aliphatic diacid monomer or aliphatic anhydride monomer includes hydrogenated phthalic anhydride, dodecenylsuccinic anhydride, hexahydro-4-methylphthalic anhydride, methylsuccinic anhydride, itaconic anhydride, 2,3-dimethylmaleic anhydride, succinic acid, oxalic acid, malonic acid, glutaric acid, adipic acid, suberic acid, azelaic acid, sebacic acid, tridecanedioic acid, tartaric acid, or a combination thereof.

In some embodiments, the polyester has a hydroxyl value of 60 mg KOH/g to 90 mg KOH/g. If the hydroxyl value of the polyester is too low, the reactive sites of the polyester will be insufficient for modification or crosslinking. If the hydroxyl value of the polyester is too high, the coating layer prepared by a coating material including the resin product will have a crosslinking density that is too high and a poor toughness, and the coating layer will be easily cracked.

One embodiment of the disclosure provides a multi-carboxylic polyester resin having a ratio of an acid value to a hydroxyl value of 1.2:1 to 2.0:1 (such as 1.3:1 to 1.9:1), and having a hydroxyl value of 35 mg KOH/g to 60 mg KOH/g. If the multi-carboxylic polyester resin has a ratio of the acid value to the hydroxyl value that is too low, the stability of the polyester dispersed in water will be poor. If the multi-carboxylic polyester resin has a ratio of the acid value to the hydroxyl value that is too high, the viscosity of the resin product will be high and be not beneficial for being used in practice. If the hydroxyl value of the multi-carboxylic polyester resin is too low, the degree of crosslinking and curing reaction will be poor. If the hydroxyl value of the multi-carboxylic polyester resin is too high, the crosslinking density will be high and the toughness of the coating layer prepared by a coating material including the resin product will be poor.

The multi-carboxylic polyester resin is formed by reacting a polyester with multi-carboxylic compound or anhydride, and the polyester has a hydroxyl value of 60 mg KOH/g to 90 mg KOH/g. For example, the polyester can be a general commercially available polyester or the described polyester, as long as the polyester has the hydroxyl value of 60 mg KOH/g to 90 mg KOH/g, and the multi-carboxylic polyester resin (formed by reacting the polyester with multi-carboxylic compound or anhydride) has the described hydroxyl value range and the described ratio of the acid value to the hydroxyl value.

In some embodiments, the polyester is the described polyester, and (d) the aliphatic diacid monomer or aliphatic anhydride monomer for forming the described polyester and the multi-carboxylic compound or anhydride have a molar ratio of 100:11 to 100:18. If the amount of the multi-carboxylic compound or anhydride is too low, the acid value of the multi-carboxylic polyester resin will be too low, and the alkaline neutralized multi-carboxylic polyester resin cannot be stably dispersed in water. If the amount of the multi-carboxylic compound or anhydride is too high, the acid value of the multi-carboxylic polyester resin will be too high, and the resin viscosity will be dramatically increased.

In some embodiments, the multi-carboxylic compound or anhydride includes trimellitic acid, trimellitic anhydride, pyromellitic anhydride, or a combination thereof. In some embodiments, the multi-carboxylic polyester resin has a weight average molecular weight (i.e., Mw) of 2000 to 20000 g/mol. If the weight average molecular weight of the multi-carboxylic polyester resin is too low, the coating layer will have poor solvent resistance and weather resistance. If the weight average molecular weight of the multi-carboxylic polyester resin is too high, it will be difficult to form a stable aqueous dispersion.

One embodiment of the disclosure provides a coating material, including: 100 parts by weight of an aqueous resin; 250 to 300 parts by weight of water; and 25 to 45 parts by weight of a curing agent. The aqueous resin is formed by neutralizing the described multi-carboxylic polyester resin with an alkaline. In some embodiments, the alkaline can be triethylamine, ammonia water, dimethylethanolamine, ethyldiisopropylamine, or a combination thereof. If the amount of water is too low, the viscosity of the coating material will be high and it will be difficult to process. If the amount of water is too high, the substrate will not be easily wetted by the coating material due to the high surface tension of water, and cratering will appear on the coating layer. If the amount of the curing agent is too low, the physical properties such as hardness or weather resistance of the coating layer will be poor. If the amount of the curing agent is too high, the coating layer will be too soft or cannot be formed. In some embodiments, the curing agent includes melamine or isocyanate. The melamine is usually used at high temperatures (120° C. to 270° C.), and the isocyanate is usually used at low temperatures (10° C. to 100° C.).

In some embodiment, the coating material may further include 1 to 150 parts by weight of pigment to change the color of the coating layer. For example, the pigment can be titanium white, cobalt blue, chrome green, or another suitable pigment.

In some embodiments, the coating material may further include 0.05 to 2 parts by weight of an auxiliary agent such as leveling agent, film-forming agent, defoaming agent, dispersant, antibacterial agent, or a combination thereof to further improve the properties of the coating material.

Below, exemplary embodiments will be described in detail so as to be easily realized by a person having ordinary knowledge in the art. The inventive concept may be embodied in various forms without being limited to the exemplary embodiments set forth herein.

### EXAMPLES

### Example 1

Ethylene glycol (20 g), neopentyl glycol (90 g), trimethylolpropane (30 g), hydrogenated phthalic anhydride (190 g), and stannous oxalate (0.3 g) were mixed and heated to 220° C. to react for 4 hours. The reaction result was diluted by xylene to obtain polyester (1) having a solid content of 75%. The polyester (1) was analyzed by an automatic potentiometric titrator to measure its acid value (<10 mg KOH/g) and hydroxyl value (77.8 mg KOH/g). The polyester (1) was analyzed by GPC (with polystyrene serving as a calibration standard) to measure its weight average molecular weight (10208 g/mol).

Trimellitic anhydride (42 g) was added to the polyester (1) (300 g), and then heated to 140° C. to react for 1 hour to form a multi-carboxylic polyester resin. The multi-carboxylic polyester resin was analyzed by the automatic potentiometric titrator to measure its acid value (62.8 mg KOH/g) and hydroxyl value (48.3 mg KOH/g), i.e., its acid value and its hydroxyl value had a ratio of 1.30:1. The multi-carboxylic polyester resin was analyzed by GPC (polystyrene serving as a standard) to measure its weight average molecular weight (11360 g/mol). The multi-carboxylic polyester resin was neutralized with triethylamine until pH value achieving 7 to 8, thereby forming a salt as an aqueous resin. Subsequently, the aqueous resin was stirred at high speed (2000 rpm) and de-ionized water was added thereto for preparing a dispersion having a solid content of 40%. The dispersion could be stably stored in an oven at 50° C. over 7 days.

11 g of a curing agent (Allnex Cymel 303, commercially available from Ching-Lin Enterprise Co., LTD), 51 g of TiO₂ (Ti-Pure R960, commercially available from PROTI CHEMICAL CO., LTD.), and 0.2 g of a leveling agent (ADDITOL-XW-395, commercially available from Ching-Lin Enterprise Co., LTD) were added to 100 g of the dispersion. The dispersion was then diluted by de-ionized water to prepare an aqueous coating material having a solid content of 50%. The aqueous coating material was coated on a galvanized steel sheet, and then dried at 200° C. for 10 minutes to obtain a coating layer. The coating layer was tested according to the standard test method ASTM D3359 to measure its adhesion (5B), and the coating layer after being dipped in boiling water for 2 hours was tested according to the standard ASTM D3359 to measure its adhesion (remained 5B). The coating layer was tested according to the standard ASTM D3363 to measure its hardness (2H), tested according to the standard ASTM D4145 to measure its flexibility (T-bend rating: 2T), and tested by the standard D5402 to measure its organic-solvent resistance (applying a force of 1 kg and rubbing with MEK-saturated cotton over 100 times). The coating layer had a Konig hardness of 215.3 seconds. The coating layer was tested according to the standard ASTM G154 cycle 2 to measure its accelerated weather-resistance (1293 hours). A coating layer formed from a general commercially available aqueous coating material PPG Aquacron® 880 was tested according to the standard ASTM G154 cycle 2 to measure its accelerated weather-resistance (about 250 hours).

### Example 2

Ethylene glycol (20 g), neopentyl glycol (90 g), trimethylolpropane (30 g), hydrogenated phthalic anhydride (190 g), and stannous oxalate (0.3 g) were mixed and heated to 210° C. to react for 12 hours. The reaction result was diluted by xylene to obtain polyester (2) having a solid content of 75%. The polyester (2) was analyzed by the automatic potentiometric titrator to measure its acid value (<10 mg KOH/g) and hydroxyl value (78.2 mg KOH/g). The polyester (2) was analyzed by GPC (polystyrene serving as a standard) to measure its weight average molecular weight (12749 g/mol).

Trimellitic anhydride (36 g) was added to the polyester (2) (300 g), and then heated to 140° C. to react for 1 hour to form a multi-carboxylic polyester resin. The multi-carboxylic polyester resin was analyzed by the automatic potentiometric titrator to measure its acid value (79.3 mg KOH/g) and hydroxyl value (41.9 mg KOH/g), i.e., its acid value and its hydroxyl value had a ratio of 1.89:1. The multi-carboxylic polyester resin was analyzed by GPC (polystyrene serving as a standard) to measure its weight average molecular weight (14286 g/mol). The multi-carboxylic polyester resin was neutralized with triethylamine until pH value achieving 7 to 8, thereby forming a salt as an aqueous resin. Subsequently, the aqueous resin was stirred at high speed (2000 rpm) and de-ionized water was added thereto for preparing a dispersion having a solid content of 40%. The dispersion could be stably stored in an oven at 50° C. over 7 days.

18 g of the curing agent (Allnex Cymel 303), 55 g of TiO₂ (Ti-Pure R⁹⁶⁰), and 0.2 g of the leveling agent (ADDITOL-XW-395) were added to 100 g of the dispersion. The dispersion was then diluted by de-ionized water to prepare an aqueous coating material having a solid content of 50%. The aqueous coating material was coated on a galvanized steel sheet, and then dried at 200° C. for 10 minutes to obtain a coating layer. The coating layer was tested according to the standard ASTM D3359 to measure its adhesion (5B). The coating layer was tested according to the standard ASTM D3363 to measure its hardness (3H), tested according to the standard ASTM D4145 to measure its flexibility (T-bend rating: 3T), and tested by the standard D5402 to measure its organic-solvent resistance (applying a force of 1 kg and rubbing with MEK-saturated cotton over 100 times). The coating layer had a Konig hardness of 204.1 seconds.

### Example 3

Ethylene glycol (20 g), neopentyl glycol (90 g), trimethylolpropane (30 g), hydrogenated phthalic anhydride (190 g), and stannous oxalate (0.3 g) were mixed and heated to 210° C. to react for 10 hours. The reaction result was diluted by xylene to obtain polyester (3) having a solid content of 75%. The polyester (3) was analyzed by the automatic potentiometric titrator to measure its acid value (<10 mg KOH/g) and hydroxyl value (76.6 mg KOH/g). The polyester (3) was analyzed by GPC (polystyrene serving as a standard) to measure its weight average molecular weight (4828 g/mol).

Trimellitic anhydride (35 g) was added to the polyester (3) (300 g), and then heated to 140° C. to react for 1 hour to form a multi-carboxylic polyester resin. The multi-carboxylic polyester resin was analyzed by the automatic potentiometric titrator to measure its acid value (60.9 mg KOH/g) and hydroxyl value (43.3 mg KOH/g), i.e., its acid value and its hydroxyl value had a ratio of 1.40:1. The multi-carboxylic polyester resin was analyzed by GPC (polystyrene serving as a standard) to measure its weight average molecular weight (5404 g/mol). The multi-carboxylic polyester resin was neutralized with triethylamine until pH value achieving 7 to 8, thereby forming a salt as an aqueous resin. Subsequently, the aqueous resin was stirred at high speed (2000 rpm) and de-ionized water was added thereto for preparing a dispersion having a solid content of 40%. The dispersion could be stably stored in an oven at 50° C. over 7 days.

10 g of the curing agent (Allnex Cymel 303), 49 g of TiO₂ (Ti-Pure R⁹⁶⁰), and 0.2 g of the leveling agent (ADDITOL-XW-395) were added to 100 g of the dispersion. The dispersion was then diluted by de-ionized water to prepare an aqueous coating material having a solid content of 50%. The aqueous coating material was coated on a galvanized steel sheet, and then dried at 200° C. for 10 minutes to obtain a coating layer. The coating layer was tested according to the standard ASTM D3359 to measure its adhesion (5B). The coating layer was tested according to the standard ASTM D3363 to measure its hardness (H), tested according to the standard ASTM D4145 to measure its flexibility (T-bend rating: 1T), and tested by the standard D5402 to measure its organic-solvent resistance (applying a force of 1 kg and rubbing with MEK-saturated cotton for 70 times). The coating layer had a Konig hardness of 190.3 seconds. The coating layer was tested according to the standard ASTM G154 cycle 2 to measure its accelerated weather-resistance (780 hours).

### Example 4

The polyester 50558-R-70 commercially available from ETERNAL MATERIALS CO. LTD. was selected to serve as polyester (4). The polyester (4) was analyzed by the automatic potentiometric titrator to measure its acid value (<10 mg KOH/g) and hydroxyl value (85.71 mg KOH/g). The polyester (4) was analyzed by GPC (polystyrene serving as a standard) to measure its weight average molecular weight (11822 g/mol).

Trimellitic anhydride (27 g) was added to the polyester (4) (300 g), and then heated to 140° C. to react for 1 hour to form a multi-carboxylic polyester resin. The multi-carboxylic polyester resin was analyzed by the automatic potentiometric titrator to measure its acid value (80.1 mg KOH/g) and hydroxyl value (42.8 mg KOH/g), i.e., its acid value and its hydroxyl value had a ratio of 1.87:1. The multi-carboxylic polyester resin was analyzed by GPC (polystyrene serving as a standard) to measure its weight average molecular weight (13359 g/mol). The multi-carboxylic polyester resin was neutralized with triethylamine until pH value achieving 7 to 8, thereby forming a salt as an aqueous resin. Subsequently, the aqueous resin was stirred at high speed (2000 rpm) and de-ionized water was added thereto for preparing a dispersion having a solid content of 40%. The dispersion could be stably stored in an oven at 50° C. over 7 days.

18 g of the curing agent (Allnex Cymel 303), 60 g of TiO₂ (Ti-Pure R⁹⁶⁰), and 0.2 g of the leveling agent (ADDITOL-XW-395) were added to 100 g of the dispersion. The dispersion was then diluted by de-ionized water to prepare an aqueous coating material having a solid content of 50%. The aqueous coating material was coated on a galvanized steel sheet, and then dried at 200° C. for 10 minutes to obtain a coating layer. The coating layer was tested according to the standard ASTM D3359 to measure its adhesion (5B). The coating layer was tested according to the standard ASTM D3363 to measure its hardness (3H), tested according to the standard ASTM D4145 to measure its flexibility (T-bend rating: 3T), and tested by the standard D5402 to measure its organic-solvent resistance (applying a force of 1 kg and rubbing with MEK-saturated cotton over 100 times). The coating layer had a Konig hardness of 195.7 seconds.

### Example 5

Ethylene glycol (20 g), neopentyl glycol (90 g), trimethylolpropane (30 g), hydrogenated phthalic anhydride (190 g), and stannous oxalate (0.3 g) were mixed and heated to 210° C. to react for 10 hours. The reaction result was diluted by xylene to obtain polyester (5) having a solid content of 75%. The polyester (5) was analyzed by the automatic potentiometric titrator to measure its acid value (<10 mg KOH/g) and hydroxyl value (76.6 mg KOH/g). The polyester (5) was analyzed by GPC (polystyrene serving as a standard) to measure its weight average molecular weight (4828 g/mol).

Trimellitic acid (39 g) was added to the polyester (5) (300 g), and then heated to 165° C. to react for 1 hour to form a multi-carboxylic polyester resin. The multi-carboxylic polyester resin was analyzed by the automatic potentiometric titrator to measure its acid value (70.6 mg KOH/g) and hydroxyl value (37.1 mg KOH/g), i.e., its acid value and its hydroxyl value had a ratio of 1.90:1. The multi-carboxylic polyester resin was analyzed by GPC (polystyrene serving as a standard) to measure its weight average molecular weight (5881 g/mol). The multi-carboxylic polyester resin was neutralized with triethylamine until pH value achieving 7 to 8, thereby forming a salt as an aqueous resin. Subsequently, the aqueous resin was stirred at high speed (2000 rpm) and de-ionized water was added thereto for preparing a dispersion having a solid content of 40%. The dispersion could be stably stored in an oven at 50° C. over 7 days.

10 g of the curing agent (Allnex Cymel 303), 49 g of TiO₂ (Ti-Pure R⁹⁶⁰), and 0.2 g of the leveling agent (ADDITOL-XW-395) were added to 100 g of the dispersion. The dispersion was then diluted by de-ionized water to prepare an aqueous coating material having a solid content of 50%. The aqueous coating material was coated on a galvanized steel sheet, and then dried at 200° C. for 10 minutes to obtain a coating layer. The coating layer was tested according to the standard ASTM D3359 to measure its adhesion (5B). The coating layer was tested according to the standard ASTM D3363 to measure its hardness (2H), tested according to the standard ASTM D4145 to measure its flexibility (T-bend rating: 1T), and tested by the standard D5402 to measure its organic-solvent resistance (applying a force of 1 kg and rubbing with MEK-saturated cotton for 94 times). The coating layer had a Konig hardness of 179.6 seconds.

### Comparative Example 1

Comparative Example 1 was similar to Example 1, and the difference in Comparative Example 1 was more trimellitic anhydride (59 g) being added to the polyester (1) (300 g), and then heated to 140° C. to react for 1 hour to form a multi-carboxylic polyester resin. The multi-carboxylic polyester resin was analyzed by the automatic potentiometric titrator to measure its acid value (93.9 mg KOH/g) and hydroxyl value (24.1 mg KOH/g), i.e., its acid value and its hydroxyl value had a ratio of 3.89:1. The multi-carboxylic polyester resin was analyzed by GPC (polystyrene serving as a standard) to measure its weight average molecular weight (12128 g/mol). The multi-carboxylic polyester resin was neutralized with triethylamine until pH value achieving 7 to 8, thereby forming a salt as an aqueous resin. Subsequently, the aqueous resin was stirred at high speed (2000 rpm) and de-ionized water was added thereto for preparing a dispersion having a solid content of 40%. The dispersion could be stably stored in an oven at 50° C. over 7 days.

11 g of the curing agent (Allnex Cymel 303), 51 g of TiO₂ (Ti-Pure R⁹⁶⁰), and 0.2 g of the leveling agent (ADDITOL-XW-395) were added to 100 g of the dispersion. The dispersion was then diluted by de-ionized water to prepare an aqueous coating material having a solid content of 50%. The aqueous coating material was coated on a galvanized steel sheet, and then dried at 200° C. for 10 minutes to obtain a coating layer. The coating layer was tested according to the standard ASTM D3359 to measure its adhesion (1B). The coating layer was tested according to the standard ASTM D4145 to measure its flexibility (T-bend rating>5T), and the coating layer was too hard and brittle. The coating layer was tested by the standard D5402 to measure its organic-solvent resistance (applying a force of 1 kg and rubbing with MEK-saturated cotton over 100 times). The coating layer had a Konig hardness of 128.7 seconds.

### Comparative Example 2

Ethylene glycol (20 g), neopentyl glycol (90 g), trimethylolpropane (30 g), hydrogenated phthalic anhydride (190 g), and stannous oxalate (0.3 g) were mixed and heated to 180° C. to react for 4 hours. The reaction result was diluted by xylene to obtain polyester (6) having a solid content of 75%. The polyester (6) was analyzed by the automatic potentiometric titrator to measure its acid value (<10 mg KOH/g) and hydroxyl value (159 mg KOH/g). The polyester (6) was analyzed by GPC (polystyrene serving as a standard) to measure its weight average molecular weight (1000 g/mol).

Trimellitic anhydride (115 g) was added to the polyester (6) (300 g), and then heated to 150° C. to react for 40 minutes, and then heated to 180° C. to confirm it was not gelled (i.e., forming a multi-carboxylic polyester resin). The multi-carboxylic polyester resin was analyzed by the automatic potentiometric titrator to measure its acid value (80.0 mg KOH/g) and hydroxyl value (14.1 mg KOH/g), i.e., its acid value and its hydroxyl value had a ratio of 5.67:1. The multi-carboxylic polyester resin was analyzed by GPC (polystyrene serving as a standard) to measure its weight average molecular weight (1326 g/mol). However, this multi-carboxylic polyester resin was too viscous to be stirred and further dispersed in water to form an aqueous resin.

### Comparative Example 3

Comparative Example 3 was similar to Example 3, and the difference in Comparative Example 3 was less trimellitic anhydride (23 g) being added to the polyester (3) (300 g), and then heated to 140° C. to react for 1 hour to form a multi-carboxylic polyester resin. The multi-carboxylic polyester resin was analyzed by the automatic potentiometric titrator to measure its acid value (52.5 mg KOH/g) and hydroxyl value (46.7 mg KOH/g), i.e., its acid value and its hydroxyl value had a ratio of 1.12:1. The multi-carboxylic polyester resin was analyzed by GPC (polystyrene serving as a standard) to measure its weight average molecular weight (5212 g/mol). The multi-carboxylic polyester resin was neutralized with triethylamine until pH value achieving 7 to 8, thereby forming a salt as an aqueous resin. Subsequently, the aqueous resin was stirred at high speed (2000 rpm) and de-ionized water was added thereto for preparing a dispersion having a solid content of 40%. The dispersion was precipitated after being stored in an oven at 50° C. for about 1 day, i.e., the degree of dispersing in water was insufficient.

11 g of the curing agent (Allnex Cymel 303), 49 g of TiO₂ (Ti-Pure R⁹⁶⁰), and 0.2 g of the leveling agent (ADDITOL-XW-395) were added to 100 g of the dispersion. The dispersion was then diluted by de-ionized water to prepare an aqueous coating material having a solid content of 50%. The aqueous coating material was coated on a galvanized steel sheet, and then dried at 200° C. for 10 minutes to obtain a coating layer. The coating layer was tested according to the standard ASTM D3359 to measure its adhesion (4B). The coating layer was tested according to the standard ASTM D4145 to measure its flexibility (T-bend rating: 1T), and cratering appeared on the coating layer. The coating layer was tested by the standard D5402 to measure its organic-solvent resistance (applying a force of 1 kg and rubbing with MEK-saturated cotton for 44 times). The coating layer had a Konig hardness of 35.1 seconds.

### Comparative Example 4

Ethylene glycol (20 g), neopentyl glycol (90 g), trimethylolpropane (40 g), hydrogenated phthalic anhydride (190 g), and stannous oxalate (0.3 g) were mixed and heated to 210° C. to react for 6 hours, and then vacuumed to 50 torrs to further react for 6 hours. The reaction result was diluted by xylene to obtain polyester (7) having a solid content of 75%. The polyester (7) was analyzed by the automatic potentiometric titrator to measure its acid value (<10 mg KOH/g) and hydroxyl value (75.1 mg KOH/g). The polyester (7) was analyzed by GPC (polystyrene serving as a standard) to measure its weight average molecular weight (22087 g/mol).

Trimellitic anhydride (34 g) was added to the polyester (7) (300 g), and then heated to 150° C. to react for 1 hour to form a multi-carboxylic polyester resin. The multi-carboxylic polyester resin was analyzed by the automatic potentiometric titrator to measure its acid value (63.6 mg KOH/g) and hydroxyl value (41.5 mg KOH/g), i.e., its acid value and its hydroxyl value had a ratio of 1.53:1. The multi-carboxylic polyester resin was analyzed by GPC (polystyrene serving as a standard) to measure its weight average molecular weight (24581 g/mol). The multi-carboxylic polyester resin was neutralized with triethylamine until pH value achieving 7 to 8, thereby forming a salt as an aqueous resin. Subsequently, the aqueous resin was stirred at high speed (2000 rpm) and de-ionized water was added thereto for preparing a dispersion having a solid content of 40%. The dispersion was precipitated after being stored in an oven at 50° C. for about 5 days.

18 g of the curing agent (Allnex Cymel 303), 55 g of TiO₂ (Ti-Pure R⁹⁶⁰), and 0.2 g of the leveling agent (ADDITOL-XW-395) were added to 100 g of the dispersion. The dispersion was then diluted by de-ionized water to prepare an aqueous coating material having a solid content of 50%. The aqueous coating material was coated on a galvanized steel sheet, and then dried at 200° C. for 10 minutes to obtain a coating layer. The coating layer was tested according to the standard ASTM D3359 to measure its adhesion (5B). The coating layer was tested according to the standard ASTM D3363 to measure its hardness (4H), and tested according to the standard ASTM D4145 to measure its flexibility (T-bend rating: 4T). The coating layer was tested by the standard D5402 to measure its organic-solvent resistance (applying a force of 1 kg and rubbing with MEK-saturated cotton over 100 times). The coating layer had a Konig hardness of 63.8 seconds.

### Comparative Example 5

Comparative Example 5 was similar to Example 5; trimellitic acid (39 g) was added to the polyester (5) (300 g), with the difference in Comparative Example 5 of being heated to 165° C. to react for 6 hours. The reaction result was gelled.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A polyester, formed by reacting monomers, wherein the monomers comprise:
15 to 20 parts by mole of (a) aliphatic triol monomer;
15 to 35 parts by mole of (b) first diol monomer;
60 to 80 parts by mole of (c) second diol monomer; and
100 parts by mole of (d) aliphatic diacid monomer or aliphatic anhydride monomer,
wherein (b) the first diol monomer has a chemical structure of 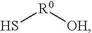
wherein R⁰ is C₂₋₆ alkylene group,
wherein (c) the second diol monomer has a chemical structure of 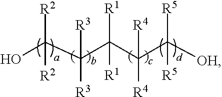
wherein each of a, b, c, and d is independently an integer of 0 to 6, and a+b+c+d≠0; and
R¹ is C₁₋₆ alkyl group, and each R¹ is the same;
R² is H or C₁₋₆ alkyl group, and each R² is the same;
R³ is H or C₁₋₆ alkyl group, and each R³ is the same;
R⁴ is H or C₁₋₆ alkyl group, and each R⁴ is the same; and
R⁵ is H or C₁₋₆ alkyl group, and each R⁵ is the same.

2. The polyester as claimed in claim 1, wherein (a) the aliphatic triol monomer comprises glycerin, trimethylolpropane, trimethylolethane, polycaprolactone triol, stigmastane-3,5,6-triol, (5alpha)-cholestane-3,5,6-triol, or a combination thereof.

3. The polyester as claimed in claim 1, wherein (b) the first diol monomer comprises ethylene glycol, 1,3-propylene glycol, 1,4-butanediol, 1,5-pentandiol, or a combination thereof.

4. The polyester as claimed in claim 1, wherein (c) the second diol monomer comprises neopentyl glycol, isopentyl glycol, 3,3-dimethyl-1,5-pentanediol, 2,5-dimethyl-2,5-hexanediol, or a combination thereof.

5. The polyester as claimed in claim 1, wherein (d) the aliphatic diacid monomer or aliphatic anhydride monomer comprises hydrogenated phthalic anhydride, dodecenylsuccinic anhydride, hexahydro-4-methylphthalic anhydride, methylsuccinic anhydride, itaconic anhydride, 2,3-dimethylmaleic anhydride, succinic acid, oxalic acid, malonic acid, glutaric acid, adipic acid, suberic acid, azelaic acid, sebacic acid, tridecanedioic acid, tartaric acid, or a combination thereof.

6. The polyester as claimed in claim 1, wherein the polyester has a hydroxyl value of 60 mg KOH/g to 90 mg KOH/g.

7. A multi-carboxylic polyester resin, having a ratio of an acid value to a hydroxyl value of 1.2:1 to 2.0:1, and having a hydroxyl value of 35 mg KOH/g to 60 mg KOH/g,
wherein the multi-carboxylic polyester resin is formed by reacting a polyester with a multi-carboxylic compound or anhydride, and the polyester has a hydroxyl value of 60 mg KOH/g to 90 mg KOH/g.

8. The multi-carboxylic polyester resin as claimed in claim 7, wherein the polyester is formed by reacting monomers, and the monomers include:
15 to 20 parts by mole of (a) aliphatic triol monomer;
15 to 35 parts by mole of (b) first diol monomer;
60 to 80 parts by mole of (c) second diol monomer; and
100 parts by mole of (d) aliphatic diacid monomer or aliphatic anhydride monomer,
wherein (b) the first diol monomer has a chemical structure of 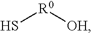
wherein R⁰ is C₂₋₆ alkylene group,
wherein (c) the second diol monomer has a chemical structure of 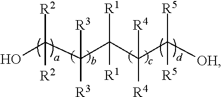
wherein each of a, b, c, and d is independently an integer of 0 to 6, and a+b+c+d≠0; and
R¹ is C₁₋₆ alkyl group, and each R¹ is the same;
R² is H or C₁₋₆ alkyl group, and each R² is the same;
R³ is H or C₁₋₆ alkyl group, and each R³ is the same;
R⁴ is H or C₁₋₆ alkyl group, and each R⁴ is the same; and
R⁵ is H or C₁₋₆ alkyl group, and each R⁵ is the same.

9. The multi-carboxylic polyester resin as claimed in claim 8, wherein (d) the aliphatic diacid monomer or aliphatic anhydride monomer and the multi-carboxylic monomer or anhydride have a molar ratio of 100:11 to 100:18.

10. The multi-carboxylic polyester resin as claimed in claim 7, wherein the multi-carboxylic monomer or anhydride comprises trimellitic acid, trimellitic anhydride, pyromellitic anhydride, or a combination thereof.

11. The multi-carboxylic polyester resin as claimed in claim 7, wherein the multi-carboxylic polyester resin has a weight average molecular weight of 2000 g/mol to 20000 g/mol.

12. A coating material, comprising:
100 parts by weight of an aqueous resin, formed by neutralizing the multi-carboxylic polyester resin as claimed in claim 7 with an alkaline;
250 to 300 parts by weight of water; and
25 to 45 parts by weight of a curing agent.

13. The coating material as claimed in claim 12, wherein the curing agent comprises melamine or isocyanate.

14. The coating material as claimed in claim 12, further comprising 1 to 150 parts by weight of pigment.

15. The coating material as claimed in claim 12, further comprising 0.05 to 2 parts by weight of an auxiliary agent.
